(19) United States
(12) Patent Application Publication
(10) Pub. No.: US 2025/0223447 A1
(43) Pub. Date: Jul. 10, 2025

(54) RENEWABLE AND SUSTAINABLE COMPOSITE WOOD COMPOSITIONS AND METHODS OF MAKING AND USING THE SAME

(71) Applicant: Trustees of Tufts College, MEDFORD, MA (US)

(72) Inventors: Fiorenzo G. Omenetto, Lexington, MA (US); Marco Lo Presti, Arlington, MA (US)

(21) Appl. No.: 19/009,373

(22) Filed: Jan. 3, 2025

Related U.S. Application Data
(63) Continuation of application No. PCT/US23/69861, filed on Jul. 10, 2023.
(60) Provisional application No. 63/368,043, filed on Jul. 8, 2022.
(60) Provisional application No. 63/482,545, filed on Jan. 31, 2023.

(51) Int. Cl. C08L 97/02; B27N 3/00; B27N 3/02; C08L 89/00; C08L 89/06

(52) U.S. Cl. CPC C08L 97/02; B27N 3/002; C08L 89/005; C08L 89/06; B27N 3/02; C08L 2205/025; C08L 2205/03

(57) ABSTRACT

An adhesive composition is disclosed including buffering and pH adjusting agents, a binder protein, an alkali lignin, and a cationic curing agent. The adhesive composition is capable of being tailored for the purpose of making particle board materials of varying degrees, by virtue of modifying the compositional makeup of the adhesive composition. The resulting particle board is free of the conventional chemicals that are present in conventional particle boards, such as formaldehyde. The result is an all-natural, biodegradable, renewable particle board material that can replace conventional materials with a fraction of the environmental impact. Additionally, the material burns much cleaner than conventional materials, so particle board burn pellets can be made from the compositions disclosed herein.

### CROSS REFERENCE TO RELATED APPLICATIONS

This application claims the benefit of International PCT App. No. PCT/US2023/069861, filed Jul. 10, 2023, and titled “RENEWABLE AND SUSTAINABLE COMPOSITE WOOD COMPOSITIONS AND METHODS OF MAKING AND USING THE SAME” (Attorney Docket No. 2095.0549).

International PCT App. No. PCT/US2023/069861 is related to and claims the benefit of priority to U.S. Provisional Patent Application 63/368,043, entitled ADHESIVE COMPOSITION FOR THE PRODUCTION OF ENGINEERED WOOD AND METHOD FOR MAKING AND USING THE SAME, and filed Jul. 8, 2022 (Attorney Docket No. 2095.0381), and U.S. Provisional Patent Application 63/482,545, entitled RENEWABLE AND SUSTAINABLE COMPOSITE WOOD COMPOSITIONS AND METHODS OF MAKING AND USING THE SAME, and filed Jan. 31, 2023 (Attorney Docket No. 2095.0382). Each of the foregoing applications are incorporated by reference in their entirety for all purposes.

### STATEMENT REGARDING FEDERALLY SPONSORED RESEARCH

This invention was made with government support under N00014-19-1-2399 awarded by the Department of Defense. The government has certain rights in the invention.

### BACKGROUND

Particle boards originated in Germany and were first produced in 1887, with an adhesive based on albumin, which was consolidated under high temperature and pressure. The first commercial particle board was produced during the Second World War. For its production, waste material was used, such as planer shavings, off-cuts or sawdust, hammer-milled into chips and these materials were bound together with a phenolic resin.

Most early particle board manufacturers use similar processes, though often with slightly different resins. However, the use of phenolic resins are of concern due to their toxicity, instability during storage, polluting behavior, and recent rising costs of petrol-chemicals. Alternative adhesive blends obtained from natural compounds have been proposed but most of them did not match the mechanical performances of particle board produced with phenol-formaldehyde adhesive or require pre-treatments of the raw materials increasing the process cost.

Thus, companies involved in engineered wood production may be interested in using this alternative and sustainable adhesive.

### SUMMARY

In one aspect, the present disclosure provides an aqueous liquid adhesive composition. The composition includes buffering and pH adjusting agents, a binder protein, an alkali lignin, and a cationic curing agent. The buffering and pH adjusting agents maintain the aqueous liquid adhesive composition at a pH of 7 or higher.

In another aspect, the present disclosure provides a particle board material including a filler material adhered and bonded together into a solid material by a cured version of the aqueous adhesive composition disclosed herein.

In a further aspect, the present disclosure provides a method of making a cured adhesive composition. The method includes heating the aqueous adhesive composition disclosed herein to a temperature within a predetermined curing temperature range for a predetermined curing length of time, thereby curing the aqueous adhesive composition to a cured adhesive composition.

In yet another aspect, the present disclosure provides a method of making a particle board material. The method includes mixing a filler material with the aqueous adhesive composition described herein and curing.

In another aspect, the present disclosure provides a method of using the particle board material described herein. The method includes burning the particle board material.

### BRIEF DESCRIPTION OF THE FIGURES

The disclosure and the following detailed description of certain embodiments thereof may be understood by reference to the following figures:

FIG. 1 depicts lap shear results of different composition of gelatin and lignin cured with CaCl₂ or MgCl₂.

FIG. 2A and FIG. 2B depict a particleboard specimen obtained from sawdust, gelatin and lignin.

FIG. 3A depicts load vs deflection plots of static bending of particleboard panels made with gelatin.

FIG. 3B depicts load vs deflection plots of static bending of particleboard panels made with casein.

FIG. 4 depicts static bending of MDPB realized without gelatin (upper curve) or lignin (lower curve).

FIG. 5A depicts a force vs displacement plot of internal bonding of wood panels.

FIG. 5B depicts detail of a fractured panel during the measurement.

### DETAILED DESCRIPTION

Before the present invention is described in further detail, it is to be understood that the invention is not limited to the particular embodiments described. It is also understood that the terminology used herein is for the purpose of describing particular embodiments only, and is not intended to be limiting. The scope of the present invention will be limited only by the claims. As used herein, the singular forms “a”, “an”, and “the” include plural embodiments unless the context clearly dictates otherwise.

It should be apparent to those skilled in the art that many additional modifications beside those already described are possible without departing from the inventive concepts. In interpreting this disclosure, all terms should be interpreted in the broadest possible manner consistent with the context. Variations of the term “comprising” should be interpreted as referring to elements, components, or steps in a non-exclusive manner, so the referenced elements, components, or steps may be combined with other elements, components, or steps that are not expressly referenced. Embodiments referenced as “comprising” certain elements are also contemplated as “consisting essentially of” and “consisting of” those elements. When two or more ranges for a particular value are recited, this disclosure contemplates all combinations of the upper and lower bounds of those ranges that are not explicitly recited. For example, recitation of a value of between 1 and 10 or between 2 and 9 also contemplates a value of between 1 and 9 or between 2 and 10.

In places where ranges of values are given, this disclosure explicitly contemplates other combinations of the lower and upper limits of those ranges and sub-ranges that fall therein, which may not be explicitly recited. For example, recitation of a value between 1 and 10 also contemplates values, e.g., from 2 to 9, from 2 to 8, or from 3 to 4. Ranges identified as being “between” two values are inclusive of the end-point values. For example, recitation of a value between 1 and 10 includes the values 1 and 10.

Features of this disclosure described with respect to a particular method, apparatus, composition, or other aspect of the disclosure can be combined with, substituted for, integrated into, or in any other way utilized with other methods, apparatuses, compositions, or other aspects of the disclosure, unless explicitly indicated otherwise or necessitated by the context. For clarity, an aspect of the invention described with respect to one method can be utilized in other methods described herein, or in apparatuses or with compositions described herein, unless context clearly dictates otherwise.

As used herein, “substantially free of” refers to having a weight content of equal to or less than about 0.1% by weight, less than about 0.05% by weight, less than about 0.01% by weight, or less than about 0.001% by weight of a composition, such as an alkali lignin or adhesive composition.

### Compositions

In an aspect, the present disclosure provides an aqueous liquid adhesive composition. The aqueous liquid adhesive composition includes buffering and pH adjusting agents, binder protein, an alkali lignin, and a cationic curing agent. The buffering and pH adjusting agents maintain the aqueous liquid composition at a pH of 7 or higher.

The buffering and pH adjusting agents can maintain a pH of 7 or higher, including but not limited to, a pH of between 8 and 11.

The binder protein can in general be a protein that has amino acid content that is adequately similar to the exemplified binder protein to afford adequate performance for the adhesive composition. In other words, so long as a protein has some degree of similarity with and is not too far of an outlier in terms of amino acid content when compared with animal protein products such as gelatin or casein, the protein would be expected to be a suitable binder protein. With that being said, the specific species of proteins that are recited are quite appealing options, due to their ability to be sourced from animal byproducts. Two specific exemplary binder proteins are gelatin and casein. In some cases, the binder protein is a byproduct of a butchering and/or food manufacturing process.

In some cases, the binder protein is gelatin. The gelatin can be derived from porcine skin type A or porcine skin type B. In some cases, the gelatin is derived from porcine skin type A. In some cases, the gelatin is derived from porcine skin type B.

In some cases, the binder protein is casein. The casein can be derived from a dairy product, such as cow's milk.

In some aspects, the binder protein can be present in the aqueous liquid in an amount of between 1% and 25% by weight. This includes but is not limited to compositions of at least 1%, at least 2%, at least 3%, at least 4%, at least 5%, at least 6%, at least 7%, at least 8%, at least 9%, or at least 10% and at most 25%, at most 23%, at most 21%, at most 20%, at most 19%, at most 18%, at most 17%, at most 16%, at most 15%, at most 14%, at most 13%, at most 12%, at most 11%, at most 10%, at most 9%, or at most 8%. In some aspects, the binder protein is present in an amount of between 5% and 10%, between 6% and 9%, between 7% and 8%, or a range including any one of the lower limits of the aforementioned ranges combined with any one of the upper limits of the aforementioned ranges. In some aspects, the binder protein is present in an amount that is tailored to provide a desired cured adhesive property.

The alkali lignin can be a Kraft lignin. In some aspects, the alkali lignin has a sulfonate content of 5 mmol/g or less, 3 mmol/g or less, 2 mmol/g or less, 1 mmol/g or less or a sulfur content of 4% by weight or less. In other aspects, the alkali lignin can be substantially free of sulfonate or sulfur content.

In some cases, the alkali lignin can be present in an amount of between 25 mg/mL and 500 mg/mL, between 25 mg/mL and 250 mg/mL, or between 25 mg/mL and 150 mg/mL. In some aspects, the amount of alkali lignin present is expected to impact the adhesive properties of the composition.

The cationic curing agent can be Mg²⁺, Ca²⁺, or a combination thereof. The cationic curing agent can be present in a concentration of between 0.1 M and 3.0 M, between 0.1 M and 2.0 M, or between 0.1 M and 1.0 M. In some aspects, the curing agent is present in an amount of between 0.5 M and 1.5 M, between 1.5 M and 2.5 M, between 1.0 M and 2.0 M, between 2.0 M and 3.0 M or a range including any one of the lower limits of the aforementioned ranges combined with any one of the upper limits of the aforementioned ranges.

A particle board material can be made of a filler material adhered and bonded together into a solid material by curing the adhesive composition. A skilled artisan will recognize that the material properties of the particle board material can be altered by adjusting the relative proportions of the ingredients in the particle board material. As a general rule of thumb, smaller dimensioned filler material requires a larger proportional amount of adhesive composition, though there may be exceptions to that generalization. Specifically, the inventors surprisingly discovered that the different densities of particle board material required adhesive compositions having unexpectedly different material composition. Specifically, while the generalized formula for an adhesive composition provides good performance across the disclosed ranges of components, exceptional performance was identified with two different subsets of compositions, one each for medium-density and high-density particle board materials.

In general, the particle board material can include filler material in an amount by weight of between 60% and 95% and adhesive composition in an amount by weight of 5% to 40%. In general, the components of the adhesive composition are present in the particle board material in their relative amounts by weight in a dry solid basis, as it is believed that the curing process effectively eliminates the water from the aqueous curing composition. Without wishing to be bound by any particular theory, to the extent that water content is retained within the particle board material, a skilled artisan will recognize how to mathematically compensate for that water content when determining the relative proportions of components in the aqueous adhesive composition and particle board materials. The components of the aqueous adhesive composition can be present in the dry solids basis amount by weight: the protein binder between 50% and 85%; the alkali lignin between 10% and 45%; and the cationic curing agent between 1% and 20%.

The present disclosure provides a medium-density particle board (MDPB) material. Without wishing to be limited by the definition provided therein, the MDPB material meets the material requirements to be categorized as MDPB according to ASTM D1037-12 (2020), which is incorporated herein in its entirety by reference for all purposes. The MDPB material can include filler material in an amount by weight of between 80% and 95%, binder protein in an amount by weight of between 5% and 15%, alkali lignin in an amount by weight of between 1% and 10%, and cationic curing agent in an amount by weight of between 0.5% and 10%.

The present disclosure provides a MDPB adhesive composition that is combinable with a filler material to make an exceptional MDPB material that does not include petroleum-derived products. The MDPB adhesive composition can include the following in a dry solid basis weight percentage: the protein binder between 60% and 75%; the alkali lignin between 10% and 35%; and the cationic curing agent between 5% and 20%.

The present disclosure provides a high-density particle board (HDPB) material. Without wishing to be limited by the definition provided therein, the HDPB material meets the material requirements to be categorized as HDPB according to ASTM D1037-12 (2020), which is incorporated herein in its entirety by reference for all purposes. The HDPB material can include filler material in an amount by weight of between 65% and 80%, binder protein in an amount by weight of between 10% and 25%, alkali lignin in an amount by weight of between 5% and 15%, and cationic curing agent in an amount by weight of between 0.1% and 10%.

The present disclosure provides a HDPB adhesive composition that is combinable with a filler material to make an exceptional HDPB material that does not include petroleum-derived products. The HDPB adhesive composition can include the following in a dry solids basis weight percentage: the protein binder between 50% and 70%; the alkali lignin between 25% and 45%; and the cationic curing agent between 0.5% and 20%.

The present invention relates to an aqueous liquid adhesive composition and other articles made with such compositions, and methods for making and using those described anywhere herein. For the avoidance of doubt, features described in this section are combinable with features in the following section and vice versa.

### Methods of Making

The present disclosure provides a method of making a cured adhesive. The method of making a cured adhesive includes heating an adhesive composition as disclosed anywhere herein to a temperature within a predetermined temperature range for a predetermined length of time to cure in order to cure the adhesive composition. For the avoidance of doubt, any composition described in the previous section discussing adhesive compositions can be made by the methods of making described herein.

In some cases, the heating is performed at a predetermined elevated pressure above atmospheric pressure. In some cases, the predetermined elevated temperature is between 40° C. and an upper temperature limit. Specifically, the upper temperature limit can be a melting or combustion point of any of the components of the aqueous liquid adhesive composition. In some cases the elevated temperature is at least 50° C., at least 60° C., at least 70° C., at least 80° C., or at least 90° C. and at most 300° C., at most 200° C., at most 150° C., at most 100° C., at most 90° C., or at most 80° C. In some cases the elevated temperature is between 80° C. and 100° C. In some cases, the upper temperature limit can be 300° C. or 150° C. The amount of time it takes for curing the adhesive can be dependent on the predetermined elevated temperature. The curing time can depend on temperature, surface area of the particle board, moisture content, temperature, pressure, and these parameters (for example, temperature and pressure) are selected so as to achieve the desired cured adhesive composition.

In some cases, the predetermined elevated pressure is between 0.1 MPa and 10 MPa, between 0.1 MPa and 5 MPa, or between 0.1 MPa and 3.0 MPa. In some cases the elevated pressure is at least 0.1 MPa, at least 0.5 MPa, at least 1 MPa, at least 2 MPa, or at least 3 MPa, at least 4 MPa, at least 5 MPa, at least 6 MPa, at least 7 MPa, at least 8 MPa and at most 10 MPa, at most 9 MPa, at most 8 MPa, at most 7 MPa, at most 6 MPa, or at most 5 MPa. In some cases, the predetermined elevated pressure is between 1 MPa and 3 MPa, between 3 MPa and 5 MPa, between 5 MPa and 7 MPa, between 7 MPa and 9 MPa, or a range including any one of the lower limits of the aforementioned ranges combined with any one of the upper limits of the aforementioned ranges. The amount of time it takes for curing the adhesive can be dependent on the predetermined elevated pressure. The curing time can depend on temperature, surface area of the particle board, moisture content, temperature, pressure, and these parameters (for example, temperature and pressure) are selected so as to achieve the desired cured adhesive composition. Without wishing to be bound by any particular theory, it is believed that the pressure can affect the final density and mechanical properties. In some cases, using a pressure that is too low can provide a material that is too brittle. However, it may be possible that the elevated temperature does not need to be sustained throughout the application of the elevated pressure. In some cases, the elevated temperature is maintained throughout the application of the elevated pressure.

The present disclosure also provides a method of making a particle board material. The method of making a particle board material includes mixing a filler material with the adhesive composition prior to the heating.

In some cases, the filler material used to make the particle board is plant-derived material and/or a textile, for example the filler material can be made from pieces or remnants of silk, wool, linen, cotton, such synthetic fibers as rayon, nylon, polyesters, paper sources, plants, or trees. In some cases, the filler material includes a mixture of materials, for example filler materials from a paper source and filler materials from a textile source, for example cotton.

In some cases, the filler material used to make the particle board is wood. In these cases, the filler materials are made of wood chips, wood sawdust, wood waste, wood fibers, or any combination thereof.

In some cases, the filler material used to make the particle board has a density of between 0.1 g/cm³ and 1.5 g/cm³, between 0.2 g/cm³ and 0.3 g/cm³, between 0.5 g/cm³ and 0.8 g/cm³, including but not limited to, at least 0.1 g/cm³, at least 0.2 g/cm³, at least 0.3 g/cm³, or at least 0.5 g/cm³, and at most 1.5 g/cm³, at most 1.2 g/cm³, at most 1.0 g/cm³, at most 0.8 g/cm³, at most 0.5 g/cm³, or at most 0.3 g/cm³. In some cases, filler material used to make the particle board has a density between 0.1 g/cm³ and 0.5 g/cm³, between 0.5 g/cm³, and 1.0 g/cm³, and between 1.0 and 1.5 g/cm³. In some cases, the filler material used to make the particle board has a density between 0.2 g/cm³ and 0.4 g/cm³, between 0.4 g/cm³ and 0.6 g/cm³, between 0.6 g/cm³ and 0.8 g/cm³, and between 0.8 g/cm³ and 1.0 g/cm³ or a range including any one of the lower limits of the aforementioned ranges combined with any one of the upper limits of the aforementioned ranges.

In some cases, the particle board material has an internal bonding of at least 0.10 MPa, at least 0.15 MPa, at least 0.20 MPa, at least 0.25 MPa, at least 0.30 MPa, at least 0.35 MPa, at least 0.40 MPa, at least 0.45 MPa, at least 0.50 MPa, and at most 2.0 MPa, at most 1.75 MPa, at most 1.50 MPa, at most 1.25 MPa, at most 1.00 MPa, at most 0.90 MPa, at most 0.80 MPa, at most 0.75 MPa, at most 0.70 MPa, at most 0.65 MPa, at most 0.60 MPa, at most 0.55 MPa, at most 0.50 MPa, at most 0.45 MPa, at most 0.40 MPa, and at most 0.35 MPa. Internal bonding is measured by European norm EN 312, which specifies a method for the determination of the resistance of fiberboards and particleboards to axial withdrawal of screws. One suitable test is described in Ping, L., Pizzi, A., Guo, Z. D., & Brosse, N. (2011), Condensed tannins extraction from grape pomace: Characterization and utilization as wood adhesives for wood particleboard. Industrial Crops and Products, 34 (1), 907-914, which is incorporated herein in its entirety by reference for all purposes.

In some cases, the particle board material has a modulus of elasticity of between 100 MPa and 5000 MPa, between 100 MPa and 2500 MPa, or between 100 MPa and 1000 MPa. In some cases, the particle board material has a modulus of elasticity of between 150 MPa and 500 MPa, between 250 MPa and 500 MPa, between 350 MPa and 600 MPa, between 500 MPa and 750 MPa, between 600 and 850 MPa, between 900 MPa and 1200 MPa, between 1500 MPa and 2500 MPa, and between 3000 MPa and 5000 MPa or a range including any one of the lower limits of the aforementioned ranges combined with any one of the upper limits of the aforementioned ranges. In some cases, the particle board has a modulus of elasticity of at least 100 MPa, at least 300 MPa, at least 500 MPa, at least 800 MPa, at least 1200 MPa, at least 1500 MPa, at least 2500 MPa, at least 3000 MPa, and at most 5000 MPa, at most 4000 MPa, at most 3000 MPa, at most 2000 MPa, at most 1500 MPa, at most 1000 MPa, at most 800 MPa, and at most 500 MPa.

In some cases, the particle board has a modulus of rupture of between 1 MPa and 20 MPa, between 1 MPa and 15 MPa, or between 1 MPa and 10 MPa. In some cases, the particle board material has a modulus of rupture of between 1 MPa and 5 MPa, between 2 MPa and 5 MPa, between 3 MPa and 6 MPa, between 5 MPa and 7 MPa, between 6 MPa and 9 MPa, between 10 MPa and 13 MPa, between 15 MPa and 18 MPa, and between 15 MPa and 20 MPa or a range including any one of the lower limits of the aforementioned ranges combined with any one of the upper limits of the aforementioned ranges. In some cases, the particle board has a modulus of rupture of at least 1 MPa, at least 3 MPa, at least 5 MPa, at least 8 MPa, at least 12 MPa, at least 15 MPa, at least 18 MPa, and at most 20 MPa, at most 18 MPa, at most 15 MPa, at most 12 MPa, at most 10 MPa, at most 8 MPa, at most 5 MPa, and at most 3 MPa.

In some cases, the aqueous liquid adhesive composition, particle board material, or method as disclosed anywhere herein is substantially free of petroleum products.

In some cases, the aqueous liquid adhesive composition, particle board material, or method as disclosed anywhere herein is substantially free of formaldehyde.

In some cases, the materials disclosed herein can be provided in the form of pellets, which can be used in wood-heating systems and methods.

### Methods of Using

The present disclosure provides a method of using a particle board material as disclosed anywhere herein. The method includes burning the particle board material. Due to the absence of petroleum-based products in the presently disclosed particle board material, the particle board material is substantially free of formaldehyde and displays no volatile organic compound emissions. The particle board material is also absent of inorganic volatile compounds and glues. The particle board material is made from sustainable materials and renewable resources. The byproducts of the method of making the particle board material are recyclable. The material has biodegradability without leeching harsh chemicals. Byproducts, including those which can cause workers health harms, will have fewer harsh chemicals in them, such as formaldehyde. The material burns clean. For all of these advantages, the material is incredibly low cost.

In some cases, the method of using can include burning the disclosed material. Such use provides an unexpectedly superior impact upstream (e.g., sustainable and renewable sourcing) and downstream (e.g., cleaner emissions) of the burning.

### EXAMPLES

### Example 1

In Example 1, a composition comprising gelatin, lignin and magnesium ions is used in the production of particle board and other engineered wood composites. The composition enables the recycling of wood waste, thus reducing the emission of greenhouse gases using an adhesive made from gelatin and lignin which are both recovered as by-products from several food industry processes and agro-industrial production respectively, thus offering a totally sustainable process for the production of engineered wood.

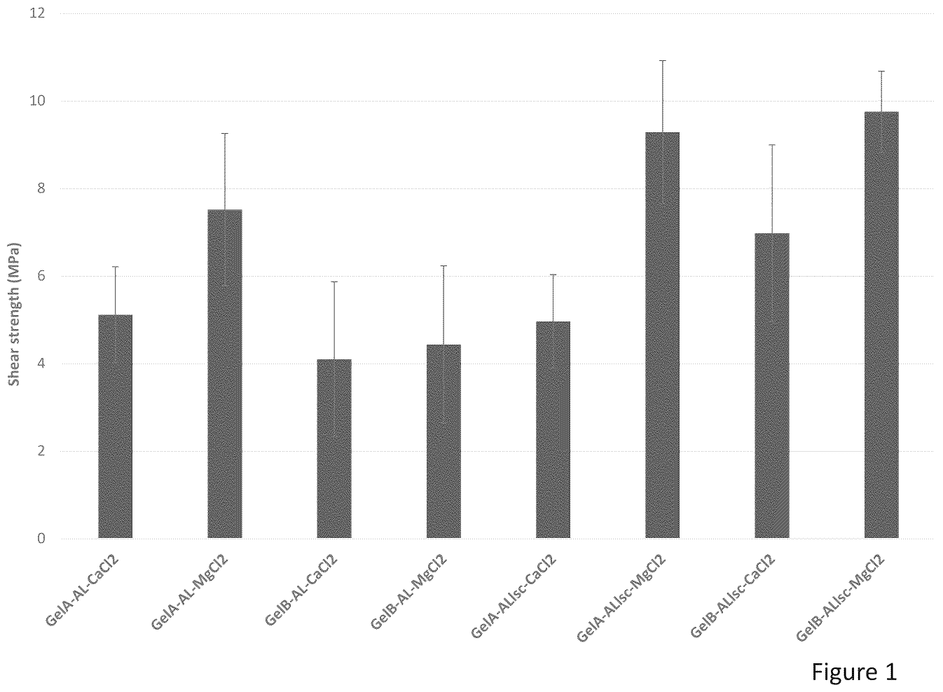

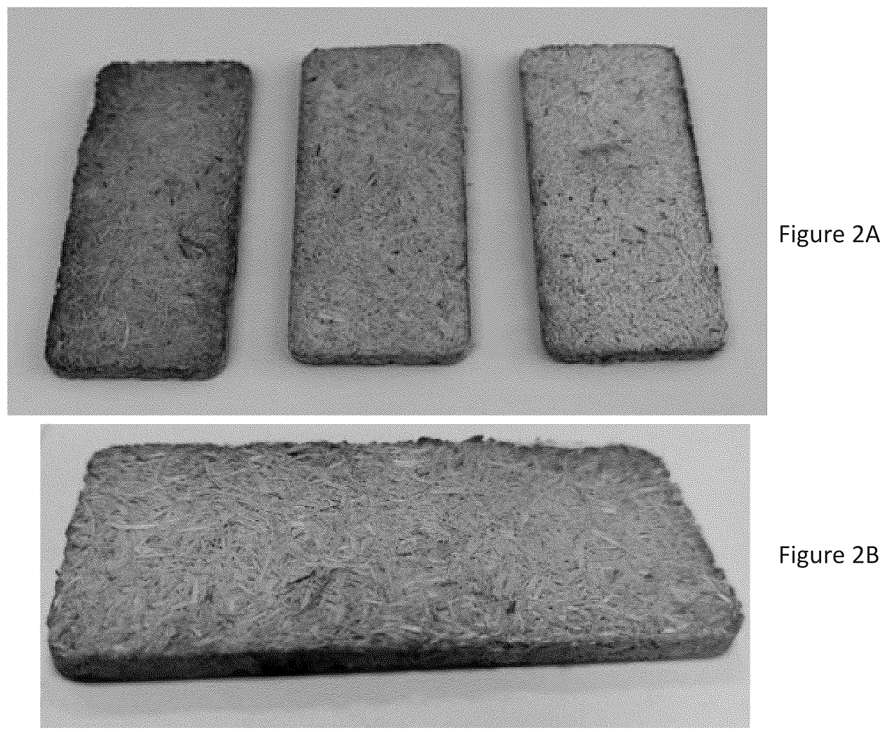

Example 1 comprises a solution of gelatin from porcine skin type A (gelA) or B (gelB) at 7% with the addition of Alkali lignin from Kraft process (AL) or alkali lignin with low sulfonate content (AL_{lsc}) at the concentration of 10 mg/mL in a 0.4M borate buffer (pH 9.5). The adhesion performance of these formulations in lap shear tests onto stainless steel adherent after curing the formulations with the addition of either CaCl₂) or MgCl₂ and heating at 60° for 48 h and the results are reported in FIG. 1. All the compositions displayed high performance of shear strength (≥4 Mpa) and in particular, those employing low sulfonate content lignin (AL_{lsc}) and MgCl₂ as curing agent (≥9 Mpa). The best-performing solution (GELA-AL_{lsc}) was used to create a sample of particle board. Briefly, 5 mL of the solution was mixed with 5 grams of sawdust and 1 mL of a solution of MgCl₂ 1 M was added in a rectangular-shaped mould. Finally, the mould was mechanically pressed and dried for 3 h at 150° C. and a piece of particleboard (FIG. 2A and FIG. 2B) was obtained.

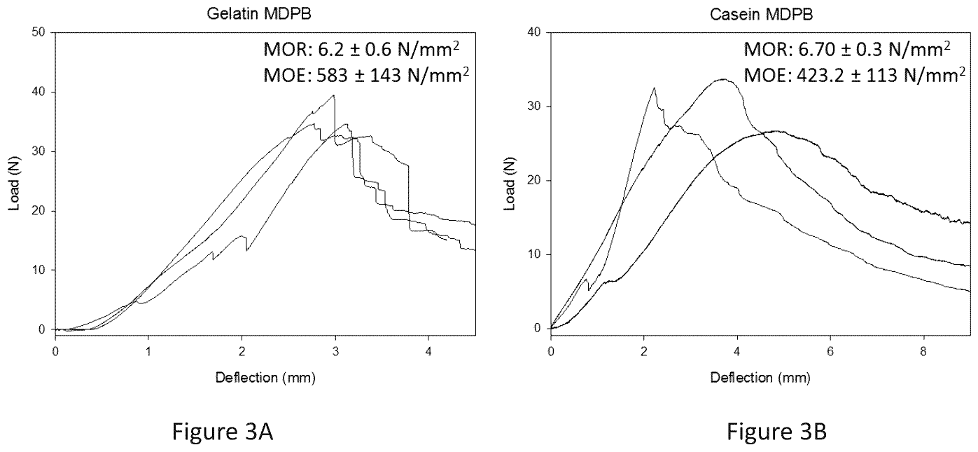

Referencing FIG. 3A and FIG. 3B, characterization of these particleboard panels following the ASTM D1037-12 (2020) method for particleboard characterization through the static bending method was completed. A sample of MDPB panels made with gelatin display a module of elasticity and a module of rupture of 583±143 N/mm² and 6.2±0.6 N/mm², respectively, which arc within the American National Standard Institute for general-purpose particleboards. Similar results were obtained using casein as protein additive instead of gelatin (module of elasticity and a module of rupture of 423.2±113 N/mm² and 6.7±0.3 N/mm², respectively).

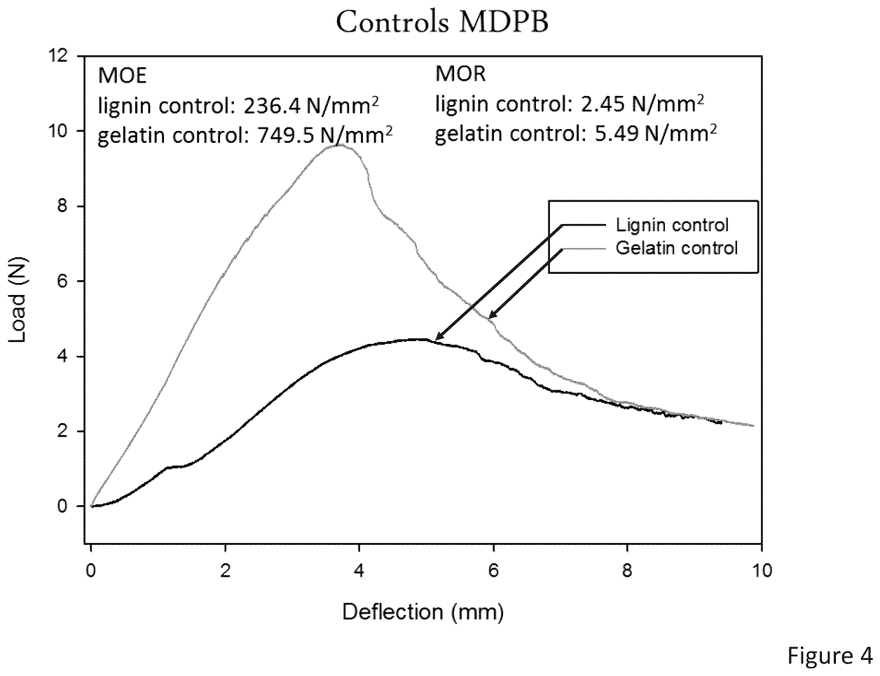

Referencing FIG. 4, control measurements were performed of certain adhesive blends avoiding the addition of gelatin (lower curve in FIG. 4) or lignin (upper curve in FIG. 4). FIG. 4 depicts a drastic reduction of static bending performances when gelatin is missing, however, the results when lignin is missing are similar to the test results depicted in FIGS. 3A and 3B (MOR: without gelatin 2.45 N/mm²; without lignin 5.49 N/mm²) (MOE: without gelatin 236.4 N/mm²; without lignin 749.5 N/mm²).

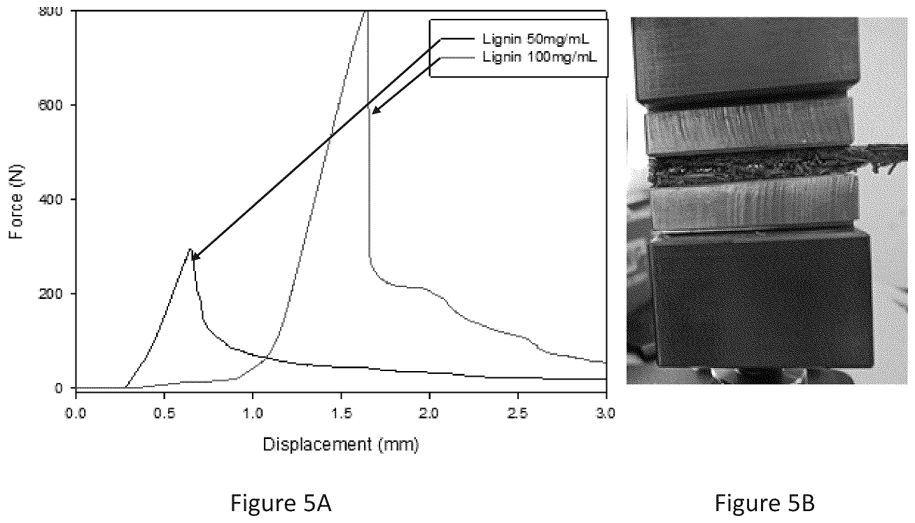

The European norm EN 312 states the minimum requirement of internal bonding (IB) for internal use of particleboard is 0.35 MPa. Two formulations composed of 5 grams of wood, 5 mL of 10% gelatin solution, 1 mL of MgCl₂ 1 M and 3 mL of a AL_{lsc} solution in NaOH 1 M with a concentration of either 50 mg/mL or 100 mg/mL were tested. In both cases, the adhesive constitutes less than 20% of the mass of particleboard. The density of the particleboard has been measured to be 0.52 gr/cm³, which is considered a medium density fiberboard by a person of skill in the art. Referencing FIG. 5A, the measured IB using 50 and 100 mg/mL of AL_{lsc} were 0.148 and 0.403 MPa respectively. Therefore, the lignin content correlates to IB performance and can match the requirement for internal use.

Table 1 reports the general solid component mass percentages for medium and high-density particleboards. In some cases, sawdust of smaller particle size may require a higher amount of adhesive.

TABLE 1

| Component | MDPB | HDPB |
|---|---|---|
| Sawdust | 87% | 73.1% |
| protein | 8.7% | 14.6% |
| Lignin | 2.6% | 8.7% |
| MgCl₂ | 1.7% | 0.35% |

The water-swelling behavior of medium-density particleboard made with either gelatin or casein following the ASTM D1037-12 (2020) standard was assessed. Casein-based MDPB had an initial mass (WA %) of 27.2 g and initial thickness of 2.4±0.4 mm and gelatin-based MDPB had an initial mass (WA %) of 27.8 g and initial thickness of 2.0±0.4 mm. After 2 hours of soaking in water, the mass increased to 53.32 g (+96%) and 48.9 g (+75%), respectively, and the thickness increased to 2.9±0.4 mm (+20%) and 2.4±0.4 mm (+20%), respectively. After 24 hours of soaking in water, the mass increased to 58.65 g (+115%) and 52.9 g (+90%), respectively, and the thickness increased to 3.0±0.5 mm (+25%) and 2.5±0.4 mm (+25%), respectively. These values are significantly lower compared to other particleboards obtained with phenol- or urea-formaldehyde resins.

### Example 2

Example 2 comprises a petroleum-free particle board with substantially similar mechanical properties to regular construction materials but without inorganic volatile compounds and glues. The particle board of Example 2 comprises wood powders or shavings that are mixed with gelatin binders and subjected to thermal compression. The composition of Example 2 includes gelatin and lignin as raw materials and the production of particleboards is performed following the currently employed industrial procedure (hot press). Due to the absence of petroleum-based product, the particleboard is formaldehyde-free and displays no VOCs emission. Since the particleboard is produced from waste products from other industrial processes, the price of the binders is very cost-effective. With a density of 0.5 g/cm³, the product is lightweight and easy to transport. Mechanical performance measured according to ASTM D1037-12 (2020) standards and revealing module of rupture of 6.25 Mpa, module of elasticity of 580 Mpa and an internal bonding of 0.4 MPa all within the EU and USA requirements for indoor use. Due to the absence of petro-chemicals, the particleboard is environmentally friendly and fully compostable.

While the disclosure has been disclosed in connection with the preferred embodiments shown and described in detail, various modifications and improvements thereon will become readily apparent to those skilled in the art. Accordingly, the spirit and scope of the present disclosure is not to be limited by the foregoing examples, but is to be understood in the broadest sense allowable by law.

1. An aqueous liquid adhesive composition comprising:
at least one of a buffering agent or a pH adjusting agent that maintains the aqueous liquid adhesive composition at a pH of 7 or higher;
a binder protein;
an alkali lignin; and
a cationic curing agent.

2. The aqueous liquid adhesive composition of claim 1, wherein the at least one buffering agent or pH adjusting agent maintains the aqueous liquid adhesive composition at a pH of between 8 and 11.

3. The aqueous liquid adhesive composition of claim 1, wherein the binder protein is present in the aqueous liquid adhesive composition in an amount by weight of between 1% and 25.

4. (canceled)

5. The aqueous liquid adhesive composition of claim 1, wherein the binder protein is present in the aqueous liquid adhesive composition in an amount that is tailored to provide a desired cured adhesive property.

6. The aqueous liquid adhesive composition of claim 1, wherein the binder protein is gelatin or casein.

7. The aqueous liquid adhesive composition of claim 1, wherein the binder protein is gelatin.

8. The aqueous liquid adhesive composition of claim 1, wherein the binder protein is casein.

9. The aqueous liquid adhesive composition of claim 1, wherein the binder protein is a byproduct of a butchering and/or food manufacturing process.

10. The aqueous liquid adhesive composition of claim 1, wherein the alkali lignin is a Kraft lignin.

11. The aqueous liquid adhesive composition of claim 1, wherein the alkali lignin has a sulfonate content of 5 mmol/g or less.

12. The aqueous liquid adhesive composition of claim 1, wherein the alkali lignin is substantially free of sulfonate content or sulfur content.

13. The aqueous liquid adhesive composition of claim 1, wherein the alkali lignin is present in the aqueous liquid adhesive composition in an amount of between 25 mg/mL and 500 mg/mL.

14. The aqueous liquid adhesive composition of claim 1, wherein the cationic curing agent is Mg²⁺, Ca²⁺, or a combination thereof.

15. The aqueous liquid adhesive composition of claim 1, wherein the cationic curing agent is present in a concentration of between 0.1 M and 3.0 M.

16. The aqueous liquid adhesive composition of claim 1, wherein the aqueous liquid adhesive composition comprises the following in a dry solids basis percentage by weight: the binder protein between 50% and 85%; the alkali lignin between 10% and 45%; and the cationic curing agent between 1% and 20%.

17. A particle board material comprising:
a filler material adhered and bonded together into a solid material by a cured version of the aqueous liquid adhesive composition of claim 1.

18-22. (canceled)

23. The particle board material of claim 17, wherein the filler material comprises at least one of a plant-derived material, a textile, wood, wood chips, wood sawdust, wood waste, wood fibers, or a combination thereof.

24. (canceled)

25. (canceled)

26. The particle board material of claim 17, wherein the particle board material has at least one of a density of between 0.1 g/cm³ and 1.5 g/cm³, an internal bonding of between 0.10 MPa and 2.0 MPa, a modulus of elasticity of between 100 MPa and 5000 MPa, a modulus of rupture of between 1 MPa and 20 MPa, or any combination thereof.

27-42. (canceled)

43. A particle board material composition, comprising:
a filler material; and
an aqueous adhesive composition, comprising:
at least one of a buffering or a pH adjusting agent that maintains the aqueous adhesive composition at a pH of 7 or higher;
a binder protein;
an alkali lignin; and
a cationic curing agent.

44. (canceled)

45. A method of making a cured adhesive composition, the method comprising:
mixing a filler material with an aqueous adhesive composition to form a mixture, the aqueous adhesive composition comprising:
at least one of a buffering or a pH adjusting agent that maintains the aqueous adhesive composition at a pH of 7 or higher;
a binder protein; and
a cationic curing agent; and
heating the mixture to a temperature within a predetermined curing temperature range for a predetermined curing length of time, thereby curing the aqueous adhesive composition to a cured adhesive composition.

46-49. (canceled)
